(19) United States
(12) Patent Application Publication
(10) Pub. No.: US 2024/0427430 A1
(43) Pub. Date: Dec. 26, 2024

(54) INFORMATION PROCESSING SYSTEM, WRITING INSTRUMENT, AND ELECTRONIC DEVICE

(71) Applicants: MITSUBISHI PENCIL COMPANY, LIMITED, Tokyo (JP); Stolia Co., Ltd, Tokyo (JP)

(72) Inventors: Takamasa FUKUDA, Tokyo (JP); Masashi SAKAGAMI, Tokyo (JP); Keiji TATANI, Tokyo (JP)

(73) Assignees: MITSUBISHI PENCIL COMPANY, LIMITED, Tokyo (JP); Stolia Co., Ltd, Tokyo (JP)

(21) Appl. No.: 18/743,456

(22) Filed: Jun. 14, 2024

(30) Foreign Application Priority Data
Jun. 20, 2023 (JP) 2023-101005

(51) Int. Cl. G06F 3/0346; B43K 7/00; B43K 23/12; B43K 29/08; G06F 3/038

(52) U.S. Cl. CPC G06F 3/0346; B43K 29/08; G06F 3/0383; B43K 7/005; B43K 23/12; G06F 2203/0384

(57) ABSTRACT

Object

To provide an information processing system and the like which enables a user to start communication between a writing instrument and an electronic device with a simple operation.

Solution

An information processing system includes a writing instrument having a communication function and an electronic device that communicates with the writing instrument. The writing instrument includes a sensor that detects a motion, a determination unit that determines whether the motion detected by the sensor is a predetermined motion, and a transmission unit that transmits a predetermined signal to the electronic device. The transmission unit transmits, to the electronic device, the predetermined signal for causing the electronic device to execute a first operation without an operation by a user, when determining that the motion detected by the sensor is the predetermined motion.

### TECHNICAL FIELD

The present invention relates to an information processing system, a writing instrument, and an electronic device.

### BACKGROUND ART

A writing instrument having a communication function and an information processing function is known. Such a writing instrument transmits data to a communication terminal of a user in response to an operation of the user and causes the communication terminal to execute a predetermined process based on the data. PTL 1 describes a writing instrument that transmits an angular velocity of the writing instrument to an information processing terminal when a user operates a button or a switch mounted at the writing instrument.

### CITATION LIST

### Patent Literature

PTL 1: JP 2019-209566 A

### SUMMARY OF INVENTION

### Technical Problem

A user may find it troublesome to operate a button or a switch of a writing instrument in order to cause the writing instrument to communicate with a communication terminal.

The present invention has been made to solve the above-described problem, and an object of the present invention is to provide an information processing system, a writing instrument, and an electronic device that enable a user to start communication between the writing instrument and the electronic device with a simple operation.

### Solution to Problem

An information processing system according to an embodiment of the present invention includes a writing instrument having a communication function and an electronic device that communicates with the writing instrument. The writing instrument includes a sensor that detects a motion, a determination unit that determines whether the motion detected by the sensor is a predetermined motion, and a transmission unit that transmits a predetermined signal to the electronic device. The transmission unit transmits, to the electronic device, the predetermined signal for causing the electronic device to execute a first operation without an operation by a user, when determining that the motion detected by the sensor is the predetermined motion.

An information processing system according to an embodiment of the present invention includes a writing instrument having a communication function and an electronic device that communicates with the writing instrument. The writing instrument includes a sensor that detects a motion and a transmission unit that transmits a signal from the sensor to the electronic device. The electronic device includes: a reception unit that receives the signal transmitted from the transmission unit; a determination unit that determines, based on the signal received by the reception unit, whether a motion of the writing instrument is a predetermined motion; and a control unit that performs control of causing the electronic device to execute a first operation without an operation by a user, when the determination unit determines that the motion of the writing instrument is the predetermined motion.

Preferably, the first operation is executed in preference to a second operation executed by the electronic device.

The first operation is preferably an operation of superimposing another indication on an indication displayed on a display, the indication being executed by the electronic device as the second operation.

The first operation is preferably an operation of inhibiting a display operation executed by the electronic device as the second operation.

A writing instrument according to an embodiment of the present invention is a writing instrument communicating with an electronic device and includes a sensor that detects a motion, a determination unit that determines whether the motion detected by the sensor is a predetermined motion, and a transmission unit that transmits a predetermined signal to the electronic device. The transmission unit transmits, to the electronic device, the predetermined signal for causing the electronic device to execute a first operation without an operation by a user, when the determination unit determines that the motion detected by the sensor is the predetermined motion.

The sensor preferably includes at least one of an acceleration sensor that detects an acceleration applied to the writing instrument, an angular velocity sensor that detects an angular velocity applied to the writing instrument, a pressure sensor that detects a pressure applied to the writing instrument during writing, and a sensor that detects knocking or rotation for causing a lead of the writing instrument to come out.

Preferably, the writing instrument further includes a cap that accommodates a magnet and is detachable from a barrel. The sensor includes a magnetic field sensor that is accommodated in the barrel and detects a magnetic field generated by the magnet. The determination unit determines whether the cap is removed from the barrel as the predetermined motion, based on the magnetic field detected by the magnetic field sensor. The transmission unit transmits the predetermined signal when the cap is removed from the barrel.

The predetermined signal is preferably a Bluetooth Low Energy (BLE) (registered trademark) beacon signal.

An electronic device according to an embodiment of the present invention is an electronic device that communicates with a writing instrument and includes a reception unit that receives a signal transmitted from the writing instrument and a control unit that executes a predetermined operation. The control unit executes a first operation without an operation by a user when the reception unit receives a predetermined signal transmitted from the writing instrument, the predetermined signal being transmitted when a predetermined motion is performed.

### Advantageous Effects of Invention

The information processing system, the writing instrument, and the electronic device according to the present invention enable a user to start communication between the writing instrument and the electronic device with a simple operation.

### BRIEF DESCRIPTION OF DRAWINGS

FIG. 1 is a schematic diagram illustrating an example of a schematic configuration of a communication system 1.

FIG. 2 is an exemplary functional block diagram of a communication terminal 2.

FIG. 3 is a perspective view of a writing instrument 3.

FIG. 4 is a cross-sectional view of the writing instrument 3.

FIGS. 5 (A) and (B) are perspective views of a fixture 44.

FIG. 6 is a perspective view of the writing instrument 3.

FIG. 7 is a cross-sectional view of the writing instrument 3.

FIG. 8 is an exemplary functional block diagram of a barrel 4.

FIG. 9 is a diagram illustrating an example of a notification screen G1.

FIG. 10 is a diagram illustrating an example of an application screen G2.

FIG. 11 is a diagram illustrating an example of the state transition of the writing instrument 3.

FIG. 12 is a sequence diagram illustrating an example of a flow of a connection process.

FIG. 13 is a diagram illustrating an example of a point management screen G3.

FIG. 14 is a diagram illustrating an example of a state display screen G4.

### DESCRIPTION OF EMBODIMENTS

Hereinafter, various embodiments of the present invention will be described with reference to the drawings. It should be noted that the technical scope of the present invention is not limited to these embodiments, but extends to the inventions described in the claims and equivalents thereof.

### Communication System

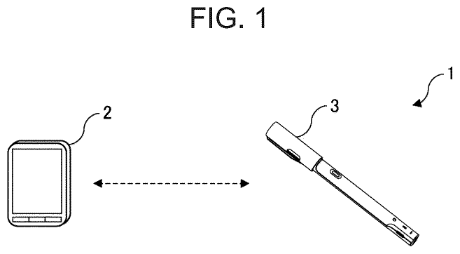

FIG. 1 is a schematic diagram illustrating a schematic configuration of a communication system 1 according to an embodiment of the present invention. The communication system 1 is an example of an information processing system. The communication system 1 includes a communication terminal 2 and a writing instrument 3.

### Communication Terminal

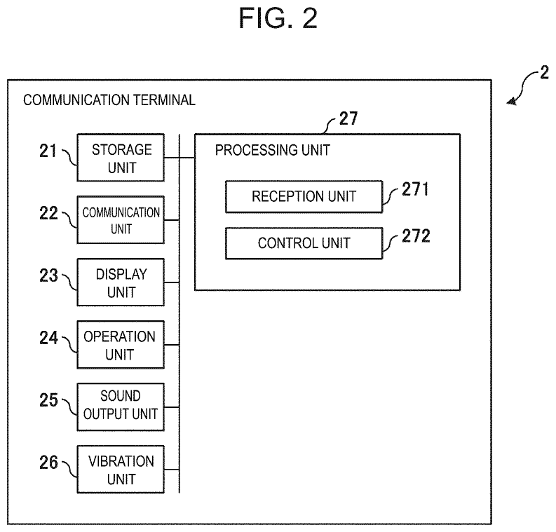

FIG. 2 is an exemplary functional block diagram of a communication terminal 2. The communication terminal 2 is an example of an electronic device. The communication terminal 2 is an information processing device such as a mobile phone, a smartphone, a personal computer (PC), a tablet terminal, or a portable game console possessed by a user of the writing instrument 3. The communication terminal 2 communicates with the writing instrument 3 and executes a predetermined operation. The communication terminal 2 includes a storage unit 21, a communication unit 22, a display unit 23, an operation unit 24, a sound output unit 25, a vibration unit 26, and a processing unit 27.

The storage unit 21 is a component for storing programs and data, and includes, for example, a semiconductor memory. The storage unit 21 stores, as programs, an operating system program, a driver program, an application program, and the like used for processing by the processing unit 27. The programs are installed in the storage unit 21 from a computer-readable and non-transitory portable storage medium such as a compact disc read only memory (CD-ROM) or a digital versatile disc read only memory (DVD-ROM).

The communication unit 22 is a component for enabling the communication terminal 2 to communicate with another device, and includes a communication interface circuit. The communication interface circuit is an interface circuit of a near field communication system such as Bluetooth Low Energy (BLE) (registered trademark). The communication unit 22 transmits data supplied from the processing unit 27 to another device, and supplies data transmitted from another device to the processing unit 27.

The display unit 23 is a component for displaying an image, and includes a display such as a liquid crystal display or an organic electro-luminescence (EL) display. The display unit 23 displays an image based on display data supplied from the processing unit 27.

The operation unit 24 is a component for receiving an operation on the communication terminal 2, and includes a button, a keyboard, a keypad, a mouse, and the like. The operation unit 24 may include a touch panel integrated with the display unit 23. The operation unit 24 generates an operation signal corresponding to a received operation and supplies the operation signal to the processing unit 27.

The sound output unit 25 is a component for outputting sound, and includes a speaker. The sound output unit 25 outputs sound based on a sound signal which is an electric signal supplied from the processing unit 27.

The vibration unit 26 is a component for vibrating the communication terminal 2, and includes a vibrator. The vibrator may be of any type, such as an eccentric rotating mass type or a linear resonant actuator type. The vibration unit 26 vibrates the communication terminal 2 based on vibration supplied from the processing unit 27.

The processing unit 27 is a component for comprehensively controlling the operation of the communication terminal 2, and includes one or a plurality of processors and peripheral circuits thereof. The processing unit 27 includes, for example, a central processing unit (CPU). The processing unit 27 may include a digital signal processor (DSP), a large scale integration (LSI), an application specific integrated circuit (ASIC), a field programmable gate array (FPGA), or the like. The processing unit 27 controls the operation of each component and executes various processes such that the various processes of the communication terminal 2 are executed in appropriate procedures in accordance with the programs stored in the storage unit 21.

The processing unit 27 includes a reception unit 271 and a control unit 272 as functional blocks. Each of these units is a functional module implemented by the processing unit 27 executing a program. Each of these units may be implemented in the communication terminal 2 as a dedicated processing circuit.

The reception unit 271 receives a predetermined signal from the writing instrument 3. The predetermined signal is transmitted when a predetermined motion is detected at the writing instrument 3. The predetermined motion includes a motion during writing. The predetermined motion may include, for example, a motion of starting writing, a motion of temporarily suspending the writing in the middle after the writing is started, and a motion while the writing instrument 3 is grasped but no writing is performed.

When the predetermined signal is received, the control unit 272 executes predetermined information processing without an operation by a user. That is, the communication terminal 2 executes the predetermined information processing in response to the transmission of the predetermined signal from the writing instrument 3. The predetermined information processing is, for example, a process of measuring a learning time in order to support learning using the writing instrument 3. In this case, the communication terminal 2 executes a clock application program installed in advance.

### Writing Instrument

The writing instrument 3 has a communication function of communicating with the communication terminal 2. In response to the detection of the predetermined motion, the writing instrument 3 transmits a predetermined signal for starting communication with the communication terminal 2 to the communication terminal 2. For example, the predetermined motion is a motion for starting writing. For example, the motion for starting writing is a motion of removing a cap of the writing instrument 3.

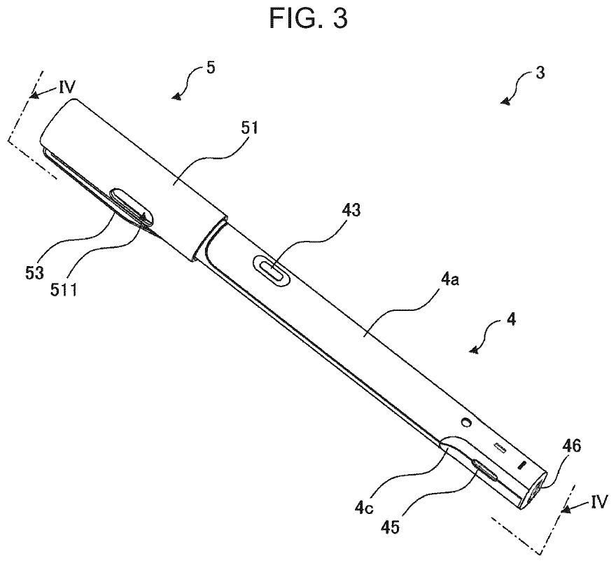

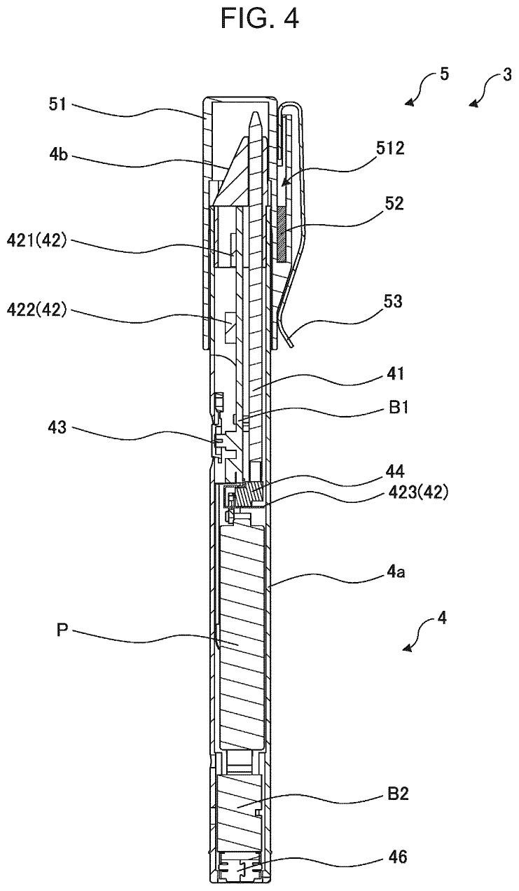

FIG. 3 is a perspective view of the writing instrument 3, and FIG. 4 is a cross-sectional view of the writing instrument 3. FIG. 4 is a cross-sectional view taken along the line IV-IV in FIG. 3. The writing instrument 3 includes a barrel 4 and a cap 5. In the following description, an end portion of the barrel 4 on a side that comes into contact with a medium such as paper during writing may be referred to as a front end of the barrel 4, and an end portion on a side opposite to the front end may be referred to as a rear end of the barrel 4. In addition, along the axial direction of the barrel 4, a side on which the front end is located may be referred to as a front side of the writing instrument 3 or the barrel 4, and a side opposite to the front side may be referred to as a rear side of the writing instrument 3 or the barrel 4.

The barrel 4 has a substantially cylindrical shape. The barrel 4 has a tubular portion 4a having a constant cross-sectional shape along the axial direction, and a tapered portion 4b formed on the front side of the tubular portion 4a and having a cross-sectional area reduced toward the front side along the axial direction. The rear end of the tubular portion 4a is formed with a notch 4c at which the cross-sectional shape of the tubular portion 4a is not circular.

The barrel 4 accommodates a writing body 41, a sensor 42, a switch 43, a fixture 44, a notification unit 45, and a charging unit 46. The barrel 4 accommodates a first substrate B1 on the front side and a second substrate B2 on the rear side. The sensor 42 and the switch 43 are disposed at the first substrate B1, and the notification unit 45 and the charging unit 46 are disposed at the second substrate B2. The first substrate B1 and the second substrate B2 are supplied with a current from a power supply P which is a secondary battery.

The writing body 41 is a member for writing on a medium. In the example illustrated in FIG. 4, the writing body 41 is a ballpoint pen refill that stores ink and transfers the ink to a medium. As illustrated in FIG. 4, the central axis of the writing body 41 does not coincide with the central axis of the barrel 4. That is, the writing body 41 is disposed eccentrically with respect to the barrel 4. Accordingly, a space for accommodating members such as the first substrate B1 is secured inside the barrel 4.

The sensor 42 is a component for detecting the motion of the barrel 4. The sensor 42 includes a magnetic field sensor 421, an inertial sensor 422, and a pressure sensor 423. The magnetic field sensor 421 is a sensor that detects a magnetic field and is, for example, a Hall sensor. The inertial sensor 422 is a sensor that detects accelerations and angular velocities in three axes applied to the barrel 4, and includes, for example, an acceleration sensor and a gyroscope sensor. The gyroscope sensor is an example of an angular velocity sensor. The pressure sensor 423 is a sensor for detecting a pressure applied to the writing body 41 from a medium during writing, and is a resistive film pressure sensor. The pressure sensor 423 is disposed such that a detection surface for detecting a pressure is orthogonal to the axial direction of the writing body 41. The sensor 42 regularly or irregularly generates information on the motion of the barrel 4.

The present disclosure is not limited to the above-described example. When the writing instrument 3 is of a knock type in which the writing body 41 is exposed from the barrel 4 by pressing a knock button, the sensor 42 may include a sensor that detects a motion of the knock button for projecting the writing body 41 of the writing instrument 3. In addition, when the writing instrument 3 is of a rotary type in which the writing body 41 is exposed from the barrel 4 by axially rotating the tubular portion 4a of the barrel 4 in a twisting manner, a sensor for detecting the rotation of the tubular portion 4a may be provided. In these cases, the sensor 42 may include an arbitrary sensor such as a button sensor, a magnetic field sensor, or an optical sensor depending on a detection target. The sensor 42 includes at least one of the various sensors described above.

The switch 43 is a component for receiving an operation by a user, and includes, for example, a tactile switch. The switch 43 is disposed so as to be capable of being pressed from the outside of the barrel 4.

The fixture 44 is a member that transmits a pressure applied to the writing body 41 to the pressure sensor 423. The fixture 44 is made of resin or metal.

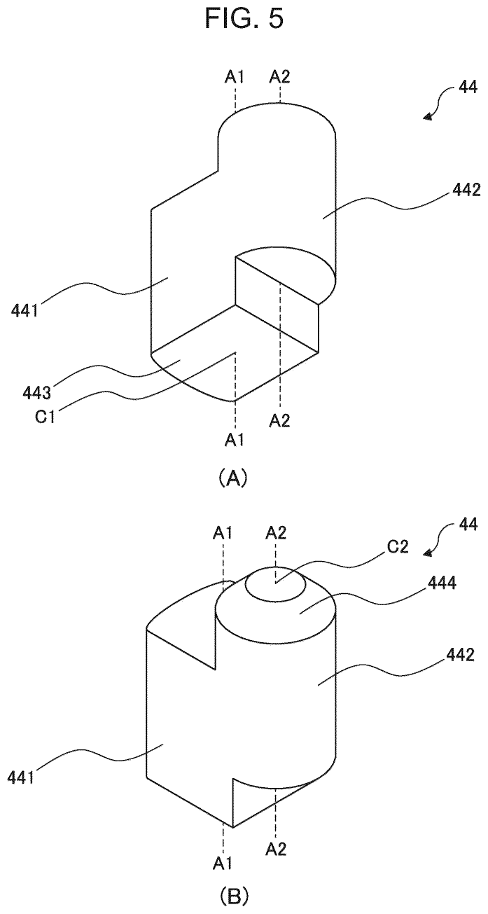

FIGS. 5 (A) and (B) are perspective views of the fixture 44. FIG. 5 (A) is a perspective view of the fixture 44 viewed from the front side, and FIG. 5(B) is a perspective view of the fixture 44 viewed from the rear side. The fixture 44 has a shape in which a first portion 441 having a substantially quadrangular prism shape and a second portion 442 having a substantially circular cylinder shape are coupled to each other while being shifted in the axial direction of the barrel 4 such that the first portion 441 is located on the front side of the second portion 442. A bottom surface 443 of the first portion 441 on the front side is in contact with the rear end of the writing body 41. A bottom surface 444 of the second portion 442 on the rear side is in contact with the detection surface of the pressure sensor 423. As illustrated in FIGS. 5 (A) and (B), an axis A1 of the first portion 441 and an axis A2 of the second portion 442 are parallel to each other and do not coincide with each other. That is, a center C1 of the bottom surface 443 and a center C2 of the bottom surface 444 are shifted from each other when viewed in the axial direction.

In order to appropriately detect a pressure by the pressure sensor 423 of a resistive film type, the area of the detection surface needs to be increased. On the other hand, as described above, in order to secure a space for accommodating the members inside the barrel 4, the writing body 41 needs to be arranged eccentrically with respect to the barrel 4. If the writing body 41 and the pressure sensor 423 are arranged such that the rear end of the writing body 41 comes into contact with the detection surface without interposition of the fixture 44, the rear end of the writing body 41 comes into contact with an end portion of the detection surface. In that case, the pressure sensor 423 of a resistive film type may not be able to appropriately detect a pressure. The fixture 44 is disposed such that the axis A1 of the first portion 441 substantially coincides with the axis of the writing body 41 and the axis A2 of the second portion 442 passes through substantially the center of the detection surface in order to enable the pressure sensor 423 to appropriately detect a pressure applied to the writing body 41. With this configuration, a pressure applied to the writing body 41 can be appropriately detected while a space for accommodating the members inside the barrel 4 is secured.

The bottom surface 444 of the fixture 44 on the rear side protrudes toward the detection surface of the pressure sensor 423. Accordingly, a pressure applied to the pressure sensor 423 increases, and thus the pressure sensor 423 can appropriately detect the pressure. The bottom surface 444 is formed in a truncated cone shape in the example illustrated in FIG. 5(B), but the bottom surface 444 is not limited to the example, and may be formed in any shape protruding toward the detection surface, such as a cone shape or a hemispherical shape.

Referring back to FIGS. 3 and 4, the notification unit 45 is a component for outputting a notification by blinking, and includes, for example, a light emitting diode (LED). The notification unit 45 is disposed near the rear end of the barrel 4. The notification unit 45 outputs a notification regarding communication between the communication terminal 2 and the writing instrument 3. For example, the notification unit 45 lights up in response to the transmission of a predetermined signal from the communication terminal 2. The notification unit 45 is not limited to such an example, and may be a speaker that outputs a notification by sound, a vibrator that outputs a notification by vibration, or the like.

The charging unit 46 is a component for charging the power supply P. The charging unit 46 includes a connection portion for connecting terminals and a power supply circuit for supplying a current from the connection portion to the power supply P to charge the power supply P. The connection portion is formed so as to be connectable with terminals conforming to a standard such as universal serial bus type C (USB-C).

The cap 5 is attachable to and detachable from the front end and the rear end of the barrel 4. The cap 5 includes a tubular body 51, a magnet 52, and a decorative member 53.

The tubular body 51 has a cylindrical shape with a bottom surface formed on one side. The inner diameter of the tubular body 51 is substantially the same as the outer diameter of the tubular portion 4a of the barrel 4. The cap 5 is attached to the front end or the rear end of the barrel 4 by accommodating the front end or the rear end of the barrel 4 in the tubular body 51.

An opening 511 is formed in a side surface of the tubular body 51. The opening 511 is formed at a position that does not overlap the tapered portion 4b of the barrel 4 when the cap 5 is attached to the front end of the barrel 4. That is, the opening 511 is formed on the rear side of the boundary between the tubular portion 4a and the tapered portion 4b of the barrel 4 when the cap 5 is attached to the front end of the barrel 4. Accordingly, even when the opening 511 is not covered with a translucent resin or the like, the airtightness of the interior of the tubular body 51 when the cap 5 is attached to the front end of the barrel 4 is improved, and thus the ink in the writing body 41 is prevented from drying.

The magnet 52 is a permanent magnet such as an alnico magnet or a ferrite magnet. The magnet 52 is accommodated in a recess 512 formed along a side surface of the tubular body 51. By accommodating the magnet 52 in the cap 5, the distance between the magnet 52 and the magnetic field sensor 421 disposed at the front side in the barrel 4 is decreased when the cap 5 is attached to the front end of the barrel 4, and the distance between the magnet 52 and the magnetic field sensor 421 is increased when the cap 5 is attached to the rear end of the barrel 4. Thus, it is possible to determine whether the cap 5 is attached to the front end of the barrel 4 based on the magnetic field detected by the magnetic field sensor 421.

The decorative member 53 is mounted on the tubular body 51 so as to cover the recess 512 in which the magnet 52 is accommodated. In the example illustrated in FIGS. 3 and 4, the decorative member 53 is a clip that can grip an object between the decorative member 53 and the tubular body 51. The decorative member 53 is not limited to such an example and may be a crown. Since the decorative member 53 covers the recess 512, the magnet 52 is prevented from falling off from the recess 512, and deterioration in appearance quality due to the recess 512 and the magnet 52 being visually recognized from the outside is prevented.

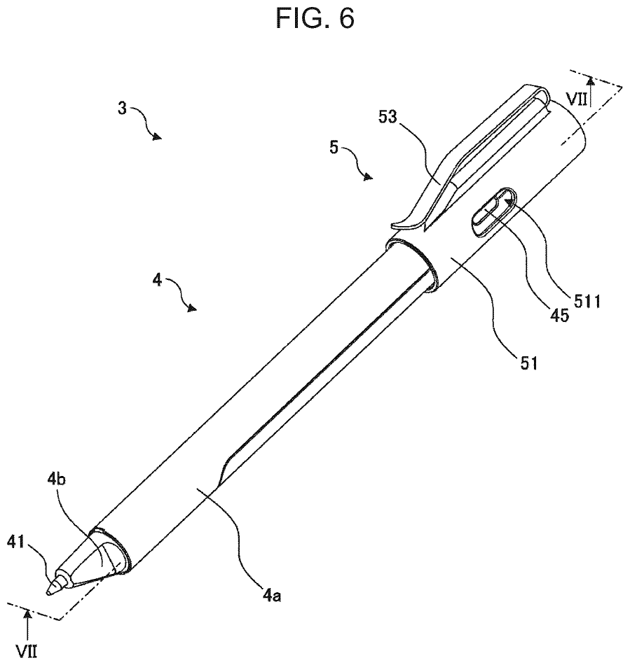

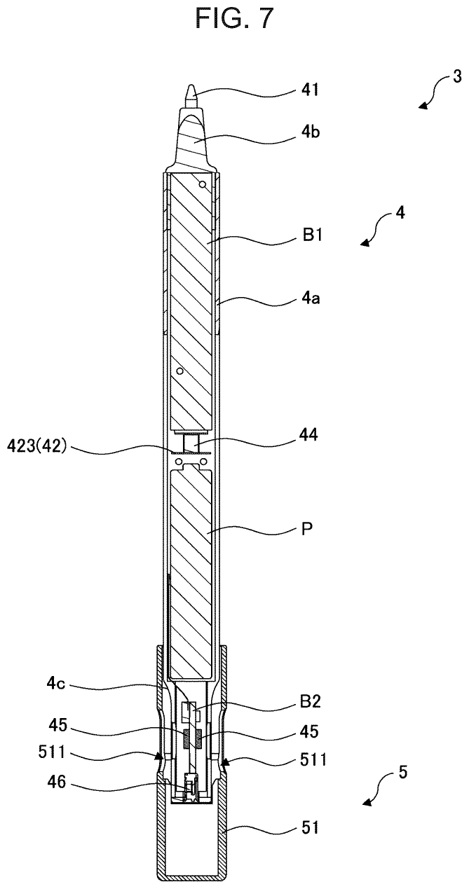

FIG. 6 is a perspective view of the writing instrument 3 in a state in which the cap 5 is removed from the front end of the barrel 4 and attached to the rear end thereof, and FIG. 7 is a cross-sectional view of the writing instrument 3. FIG. 7 is a cross-sectional view taken along the line VII-VII in FIG. 6.

As illustrated in FIGS. 6 and 7, the opening 511 is formed at a position where the notification unit 45 is visually recognizable from the outside through the opening 511 when the cap 5 is attached to the rear end of the barrel 4. As illustrated in FIG. 7, the interior of the tubular body 51 of the cap 5 has a shape complementary to the rear end of the barrel 4 so as to be engageable with the rear end of the barrel 4 at which the notch 4c is formed. Since the cross-sectional shape of the rear end of the barrel 4 is a non-circular shape due to the notch 4c, the tubular body 51 is restricted from rotating in a circumferential direction with respect to the barrel 4 in a state of being engaged with the rear end of the barrel 4. Thus, in a state in which the cap 5 is attached to the rear end of the barrel 4, the notification unit 45 is always visually recognizable through the opening 511.

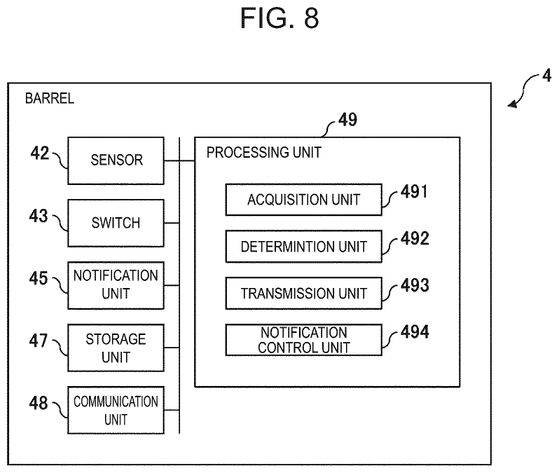

FIG. 8 is a functional block diagram of the barrel 4. The barrel 4 further includes a storage unit 47, a communication unit 48, and a processing unit 49. The storage unit 47, the communication unit 48, and the processing unit 49 are disposed at the first substrate B1, but are not illustrated in FIGS. 4 and 7. The storage unit 47, the communication unit 48, and the processing unit 49 may be disposed at the second substrate B2.

The storage unit 47 is a component for storing programs and data, and includes, for example, a semiconductor memory. The storage unit 47 stores, as programs, an operating system program, a driver program, an application program, and the like used for processing by the processing unit 49. The programs are installed in the storage unit 47 from a computer-readable and non-transitory portable storage medium such as a compact disc read only memory (CD-ROM) or a digital versatile disc read only memory (DVD-ROM).

The communication unit 48 is a component for enabling the writing instrument 3 to communicate with another device, and includes a communication interface circuit. The communication interface circuit is an interface circuit of a near field communication system such as Bluetooth Low Energy (BLE) (registered trademark). The communication unit 48 transmits data supplied from the processing unit 49 to another device, and supplies data transmitted from another device to the processing unit 49.

The processing unit 49 is a component for comprehensively controlling the operation of the writing instrument 3, and includes one or a plurality of processors and peripheral circuits thereof. The processing unit 49 includes, for example, a central processing unit (CPU). The processing unit 49 may include a digital signal processor (DSP), a large scale integration (LSI), an application specific integrated circuit (ASIC), a field programmable gate array (FPGA), or the like. The processing unit 49 controls the operation of each component and executes various processes such that the various processes of the writing instrument 3 are executed in appropriate procedures in accordance with the programs stored in the storage unit 47. For example, the processing unit 49 acquires information about a motion from the sensor 42, acquires information indicating whether the switch 43 is operated from the switch 43, and supplies a signal for outputting a notification to the notification unit 45.

The processing unit 49 includes an acquisition unit 491, a determination unit 492, a transmission unit 493, and a notification control unit 494. Each of these units is a functional module implemented by the processing unit 49 executing a program. Each of these units may be implemented in the barrel 4 as a dedicated processing circuit.

### Operation and Screen Display of Communication Terminal

The control unit 272 of the communication terminal 2 executes a first operation and a second operation in response to the transmission of a predetermined signal from the writing instrument 3. The first operation is an operation performed in preference to the second operation in response to the transmission of the predetermined signal from the writing instrument 3. For example, the first operation is an operation executed without an operation by a user. The second operation is an operation executed regardless of whether the predetermined signal has been transmitted from the writing instrument 3. For example, the second operation is an operation executed in response to an operation performed on the operation unit 24 by a user.

The first operation being executed in preference to the second operation means that the second operation is interrupted when the first operation is executed, or that the second operation is executed in parallel with the first operation when the first operation is executed. That is, the first operation being executed in preference to the second operation means that the first operation is not interrupted by the second operation. For example, when the second operation is an operation of displaying an image on the display unit 23 by an operating system program or an application program, the first operation may be an operation of displaying a banner notification so as to be superimposed on the image.

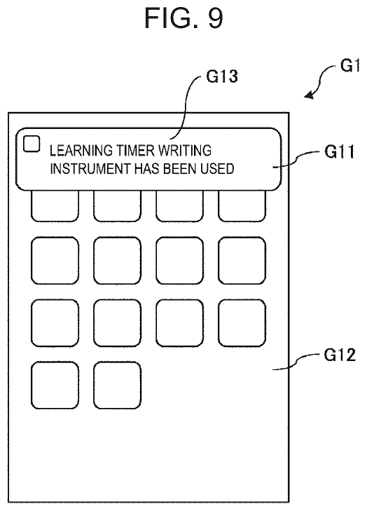

FIG. 9 is a diagram illustrating an example of a notification screen G1 displayed on the display unit 23 of the communication terminal 2 when the first and the second operations are the operations described above. The notification screen G1 is displayed when the use of the writing instrument 3 is started and a predetermined signal is transmitted from the writing instrument 3.

The notification screen G1 includes a home screen G12 and a banner notification G11. The banner notification G11 is displayed so as to be superimposed on the home screen G12. That is, the first operation of displaying the banner notification G11 is executed in preference to the second operation of displaying the home screen G12. The banner notification G11 includes a name G13 of an application program corresponding to the writing instrument 3 stored in advance in the communication terminal 2 and a message G14 indicating that the writing instrument 3 has been used. In the example illustrated in FIG. 9, “Learning Timer” is displayed as the name G13 of the application program. A user can cause the communication terminal 2 to execute the application program of the name G13 displayed in the banner notification G11 by an operation of selecting the banner notification G11.

The banner notification G11 is superimposed on the home screen G12 in the example illustrated in FIG. 9, but is not limited to such an example. The banner notification G11 may be superimposed on any screen displayed on the display unit 23 by the operating system program or the application program when a predetermined signal is transmitted from the writing instrument 3.

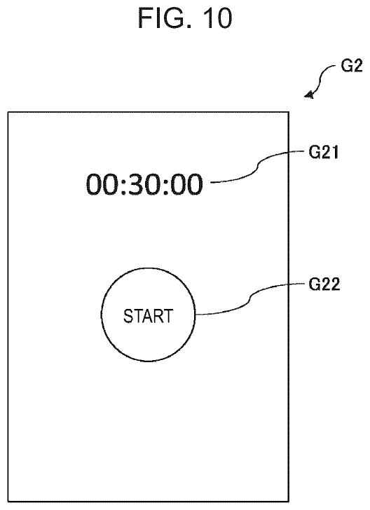

FIG. 10 is a diagram illustrating an example of an application screen G2 displayed on the communication terminal 2. The application screen G2 is displayed when the banner notification G11 is selected on the notification screen G1. This selection is performed by an operation on the operation unit 24. When the operation unit 24 includes a touch panel, the selection is performed by an operation of tapping the touch panel. The application screen G2 may be displayed when an operation of causing the communication terminal 2 to execute an application program corresponding to the writing instrument 3 is performed.

The application screen G2 illustrated in FIG. 10 includes a timer display G21 and a start object G22. When a user selects the start object G22 (for example, taps the screen), counting of the time indicated in the timer display G21 is started. Upon elapse of the time indicated in the timer display G21, the communication terminal 2 notifies the user that the time has elapsed by sound, vibration, or the like.

In the examples illustrated in FIGS. 9 and 10, the second operation is an operation of displaying the home screen G12 on the display unit 23, and the first operation is an operation of displaying the banner notification G11 so as to be imposed on the home screen G12. The first operation and the second operation are not limited to the examples described above. For example, other examples of the first operation and the second operation include the following.
(1) The second operation may be an operation of executing a message application program that exchanges messages. In that case, the first operation executed in preference to this may be an operation of inhibiting the notification of message reception or the like which is a function of the message application program. The notification of message reception or the like is performed by displaying an image on the display unit 23, outputting sound from the sound output unit 25, or generating vibration by the vibration unit 26. That is, when the first operation is executed, notification by sound, an image, or vibration by the message application program is not performed.
(2) The second operation may be an operation of executing a telephone application program for making a voice call. In that case, the first operation executed in preference to this is an operation of inhibiting the output of a call voice or the notification of an incoming call which is a function of the telephone application program. That is, when the first operation is executed, the output of the call voice is not performed. In addition, when the first operation is executed, the notification by sound, screen display, or vibration is not performed.
(3) When an arbitrary application program is executed as the second operation, the first operation executed in preference to the arbitrary application program is an operation of outputting sound such as predetermined music.
(4) When an arbitrary application program is executed as the second operation, the first operation executed in preference to the arbitrary application program is an operation of emitting a predetermined odor. The operation of emitting an odor may be performed by an external device that communicates with the communication unit 22 of the communication terminal 2, or may be performed by the communication terminal 2 having a function of emitting an odor.
(5) When an arbitrary application program is executed as the second operation, the first operation executed in preference to the arbitrary application program is an operation of outputting a predetermined image (a still image or a moving image) to the display unit 23 of the communication terminal 2. The predetermined image may be, for example, an image indicating that the first operation is currently in a state of being prioritized.

Preferably, the first operation is, for example, an operation that does not disturb concentration during studying or writing, or an operation that exerts an effect of increasing the concentration.

The first operation preferentially executed at the communication terminal 2 in response to the transmission of a predetermined signal from the writing instrument 3 is implemented by, for example, the control unit 272 automatically starting an application program. Thus, the second operation by another application program executed at the communication terminal 2 and the second operation executed by the operating system program of the communication terminal 2 can be controlled without an operation by a user. The first operation may be implemented by an operating system stored in the communication terminal 2.

The application program automatically started in the communication terminal 2 is, for example, a program having a restriction function of inhibiting the second operation executed at the communication terminal 2 (for example, notification by sound, an image, or vibration that disturbs the concentration of a user). The application program automatically started in the communication terminal 2 may have at least one of a timer function for increasing the concentration, a function of playing music, a function of emitting an odor, and the like.

### State Transition of Writing Instrument

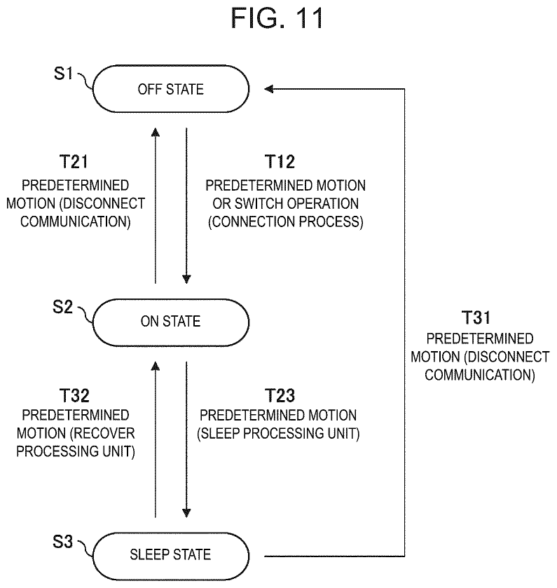

FIG. 11 is a diagram illustrating an example of the state transition of the writing instrument 3. The writing instrument 3 takes any one of an OFF state S1 in which the power supply of the communication unit 48 is off, an ON state S2 in which the power supply of the communication unit 48 is on and the communication with the communication terminal 2 is enabled, and a SLEEP state S3 for reducing the power consumption of the communication unit 48.

In the case where the writing instrument 3 is in the OFF state S1, when the motion of the writing instrument 3 detected by the sensor 42 is a predetermined motion indicating that the use of the writing instrument 3 has been started, or when the switch 43 has been operated, the writing instrument 3 transitions to the ON state S2 (transition T12). For example, the writing instrument 3 transitions to the ON state S2 when the supply of power from the power supply P to the storage unit 47 and the processing unit 49 is started. At this time, the writing instrument 3 executes a connection process for starting communication with the communication terminal 2. Details of the connection process will be described below.

The predetermined motion indicating that the use of the writing instrument 3 has been started is, for example, a motion of removing the cap 5 from the front end of the barrel 4. In this case, the acquisition unit 491 acquires information about a magnetic field generated by the magnet 52 from the magnetic field sensor 421. The determination unit 492 determines that the cap 5 has been removed from the front end of the barrel 4 when the intensity of the magnetic field indicated by the acquired information changes from a value greater than a threshold value to a value equal to or smaller than the threshold value. The threshold value is set to, for example, a value between the intensity of the magnetic field detected by the magnetic field sensor 421 in a state in which the cap 5 is attached to the front end of the barrel 4 and the intensity of the magnetic field detected by the magnetic field sensor 421 in a state in which the cap 5 is attached to the rear end of the barrel 4.

The operation of the switch 43 is, for example, an operation of continuously pressing the switch 43 for a predetermined time period (for example, 2 seconds). In this case, the determination unit 492 determines whether the switch 43 is conductive by supplying a current to the switch 43. When the switch 43 is continuously conductive for the predetermined time period or more, the determination unit 492 determines that the operation of pressing the switch 43 has been continuously performed for the predetermined time period.

In the case where the writing instrument 3 is in the ON state S2, when the motion of the writing instrument 3 is a predetermined motion indicating that the use of the writing instrument 3 has been interrupted, the writing instrument 3 transitions to the SLEEP state S3 (transition T23). For example, the writing instrument 3 transitions to the SLEEP state S3 when the supply of power from the power supply P to the processing unit 49 is stopped while the supply of power to the storage unit 47 is continued.

The predetermined motion indicating that the use of the writing instrument 3 has been interrupted is, for example, attaching the cap 5 to the front end of the barrel 4. In this case, the acquisition unit 491 acquires information about a magnetic field generated by the magnet 52 from the magnetic field sensor 421. The determination unit 492 determines that the cap 5 has been attached to the front end of the barrel 4 and the use of the writing instrument 3 has been interrupted when the intensity of the magnetic field indicated by the acquired information changes from a value equal to or smaller than the threshold value to a value greater than the threshold value.

In the case where the writing instrument 3 is in the ON state S2, when a predetermined motion indicating that the use of the writing instrument 3 has been terminated is detected, the writing instrument 3 cuts the communication with the communication terminal 2 and stop the communication unit 48 so as to transition to the OFF state S1 (transition T21). For example, the writing instrument 3 transitions to the OFF state S1 when the supply of power from the power supply P to the storage unit 47 and the processing unit 49 is stopped.

The predetermined motion indicating that the use of the writing instrument 3 has been terminated is that the writing instrument 3 does not move for a predetermined time period (for example, 10 minutes). In this case, the acquisition unit 491 acquires information on an acceleration and an angular velocity applied to the writing instrument 3 from the inertial sensor 422. In addition, the acquisition unit 491 acquires information on a pressure applied to the writing body 41 from the pressure sensor 423. The determination unit 492 determines that the writing instrument 3 has not moved for the predetermined time period and the use of the writing instrument has been terminated when the magnitudes of the acceleration, the angular velocity, and the pressure indicated by the acquired information are continuously equal to or smaller than a threshold value for the predetermined time period.

In the case where the writing instrument 3 is in the SLEEP state S3, when the motion of the writing instrument 3 is a predetermined motion indicating that the use of the writing instrument 3 has been started, the writing instrument 3 transitions to the ON state S2 (transition T32). For example, the writing instrument 3 transitions to the ON state S2 when the supply of power from the power supply P to the processing unit 49 is resumed. The predetermined motion indicating that the use of the writing instrument 3 has been started is, for example, a motion of removing the cap 5 from the front end of the barrel 4.

In the case where the writing instrument 3 is in the SLEEP state S3, when the motion of the writing instrument 3 is a predetermined motion indicating that the use of the writing instrument 3 has been terminated, the writing instrument 3 transitions to the OFF state S1 (transition T31). For example, the writing instrument 3 transitions to the OFF state S1 when the supply of power from the power supply P to the storage unit 47 is stopped. The predetermined motion indicating that the use of the writing instrument 3 has been terminated is that the writing instrument 3 does not move for a predetermined time period.

### Connection Process

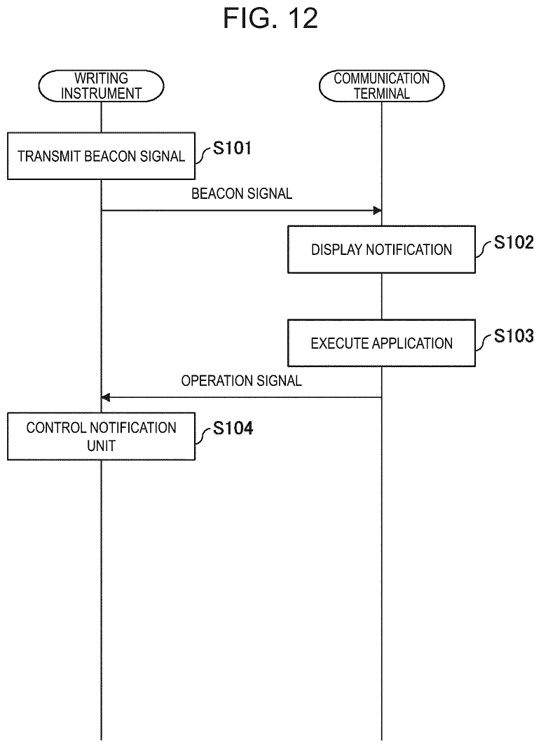

FIG. 12 is a sequence diagram illustrating an example of a flow of a connection process executed by the communication system 1. The connection process is performed in the transition T12. The processing units of the communication terminal 2 and the writing instrument 3 cooperate with other components of each device, thereby implementing the connection process.

First, the transmission unit 493 of the writing instrument 3 transmits a beacon signal (step S101). The beacon signal is an example of the predetermined signal. That is, the predetermined signal is transmitted without an operation by a user when it is determined that the motion of the writing instrument 3 is a motion related to writing. The beacon signal is, for example, a BLE beacon signal using a Bluetooth Low Energy (BLE) (registered trademark) advertise packet. The beacon signal includes information identifying the writing instrument 3.

Next, the communication terminal 2 displays a notification indicating that the use of the writing instrument 3 has been started in response to the reception of the beacon signal (step S102). The reception unit 271 of the communication terminal 2 determines that the beacon signal has been received from the writing instrument 3 when the information identifying the writing instrument 3 stored in advance is included in a predetermined frame position in the beacon signal. By displaying the notification screen G1, the control unit 272 displays a notification indicating that the use of the writing instrument 3 has been started. This notification is displayed without an operation by the user.

Next, the control unit 272 executes an application program in response to an operation by the user (step S103). The control unit 272 executes the application program corresponding to the writing instrument 3 and displays the application screen G2 in response to the user's operation of selecting (tapping the screen of) the banner notification G11 of the notification screen G1. In addition, in response to the user's operation of selecting the banner notification G11, the control unit 272 transmits an operation signal indicating that the user's operation has been received to the writing instrument 3.

Upon reception of the operation signal, the notification control unit 494 of the writing instrument 3 controls the notification unit 45 (step S104). The notification control unit 494 receives the operation signal via the communication unit 48. The notification control unit 494 controls the notification unit 45 so as to blink at predetermined intervals by supplying a current to the notification unit 45. This is the end of the connection process.

As described above, when the motion of the writing instrument 3 is the predetermined motion, the writing instrument 3 transmits the beacon signal to the communication terminal 2 without an operation of the user on the communication terminal 2 and the writing instrument 3. That is, the user does not need to operate the writing instrument 3 and the communication terminal 2 except for causing the writing instrument 3 to perform the predetermined motion for using the writing instrument. Thus, the user can cause the writing instrument 3 to communicate with the communication terminal 2 with a simple operation.

When the motion of the writing instrument 3 is a motion related to writing, the predetermined signal for causing the communication terminal 2 to execute the first operation is transmitted from the writing instrument 3 to the communication terminal 2 without an operation by the user at the communication terminal 2. Accordingly, the first operation is executed in preference to the second operation being executed in the communication terminal 2. Thus, while the user is performing a motion related to writing with the writing instrument 3, the user is less likely to be affected by the second operation executed in the communication terminal 2, such as being deprived of concentration, and is more likely to concentrate on the motion related to writing.

In addition, in the writing instrument 3, the magnet 52 is accommodated in the recess 512 formed in the cap 5. With this configuration, the magnet 52 can be accommodated in the cap 5 after molding the cap 5 without using insert molding during a manufacturing process. In the case where the magnet 52 is accommodated in the cap 5 by insert molding, manufacturing costs may increase or a magnetic force of the magnet 52 may decrease due to a high temperature during the molding. Since the magnet 52 is accommodated in the recess 512 in the writing instrument 3, the manufacturing costs of the cap 5 can be reduced and the decrease in the magnetic force of the magnet 52 can be prevented.

In addition, the writing instrument 3 determines whether the cap 5 is removed from the front end of the barrel 4 based on a magnetic field detected by the magnetic field sensor 421, and transmits a beacon signal when the cap 5 is removed from the front end of the barrel 4. Since the determination based on the magnetic field generated by the magnet 52 accommodated in the cap 5 is highly accurate, the writing instrument 3 can reliably start communication with the communication terminal 2 by a simple operation.

### Modified Example

The following modified example may be applied to the communication system 1.

In the above description, the predetermined motion indicating that the use of the writing instrument 3 has been started is a motion of removing the cap 5 from the front end of the barrel 4, but is not limited to such an example. The predetermined motion indicating that the use of the writing instrument 3 has been started may be that the writing instrument 3 is continuously moving. In that case, in the transition T12, the acquisition unit 491 acquires information on an acceleration and an angular velocity applied to the barrel 4 from the inertial sensor 422. In addition, the acquisition unit 491 acquires information on a pressure applied to the writing body 41 from the pressure sensor 423. When the magnitudes of the acceleration, the angular velocity, and the pressure indicated by the acquired information satisfy a predetermined condition, the determination unit 492 determines that the writing instrument 3 is continuously moving. The predetermined condition is, for example, that the acceleration, the angular velocity, or the pressure continuously exceeds a threshold value for a predetermined time period or more. This configuration also enables the writing instrument 3 to communicate with the communication terminal 2 with a simple operation by a user.

In the above description, the magnetic field sensor 421 is accommodated at the front side in the barrel 4, but is not limited to such an example. The magnetic field sensor 421 may be accommodated at the rear side in the barrel 4. For example, the magnetic field sensor 421 may be disposed at the second substrate B2 accommodated at the rear side in the barrel 4. In that case, in the transition T12, the writing instrument 3 determines whether the cap 5 has been attached to the rear end of the barrel 4 as the predetermined motion indicating that the use of the writing instrument 3 has been started. For example, when the intensity of the magnetic field indicated by information acquired from the magnetic field sensor 421 changes from a value equal to or smaller than a threshold value to a value greater than the threshold value, the determination unit 492 determines that the cap 5 has been removed from the front end of the barrel 4 and attached to the rear end of the barrel 4.

In the above description, the recess 512 in which the magnet 52 is accommodated is formed along the side surface of the tubular body 51, but is not limited to such an example. The recess 512 may be formed inside or outside the bottom surface of the tubular body 51. This configuration also enables the writing instrument 3 to reduce the manufacturing costs of the cap 5 and prevent decrease in the magnetic force of the magnet 52. Regardless of the above description, the magnet 52 may be accommodated in the cap 5 by insert molding.

In the above description, the transmission unit 493 transmits a BLE beacon signal when the motion of the writing instrument 3 is the predetermined motion indicating that the use of the writing instrument 3 has been started, but the present disclosure is not limited to such an example. The writing instrument 3 may transmit a signal conforming to another communication standard different from BLE.

In the above description, in step S104 of the connection process, the notification control unit 494 controls the notification unit 45 in response to the reception of an operation signal, but the present disclosure is not limited to such an example. For example, the notification control unit 494 may control the notification unit 45 to output a notification in response to the transmission of a beacon signal.

In the above description, the application program corresponding to the writing instrument 3 is an application program for measuring time, but is not limited such an example. The application program corresponding to the writing instrument 3 may be any application program. For example, the application program corresponding to the writing instrument 3 may be a calendar application program that records whether learning is performed on a daily basis.

The application program corresponding to the writing instrument 3 may be a point management application program that gives points to a user based on information acquired by the writing instrument 3 or the communication terminal 2. The point management application program may be executed as the first operation that is prioritized over the second operation executed by the communication terminal 2, or may be executed in the background of the second operation.

For example, the point management application program counts the frequency of items related to a writing operation from information detected by a sensor of the writing instrument 3 or from a result of processing the information performed by the communication terminal 2 that has received the information detected by the sensor, and performs a process of giving points to the user based on the counting result. For example, among pieces of information acquired by the writing instrument 3 or the communication terminal 2, one or more of acceleration data of the writing instrument 3, the number of times of opening and closing of the cap 5, pressure data of a sensor that detects a writing pressure, data of a sensor that detects the rotation of the writing instrument 3, the number of times of knocking of the writing instrument 3, and the like that exceed a certain threshold value may be counted.

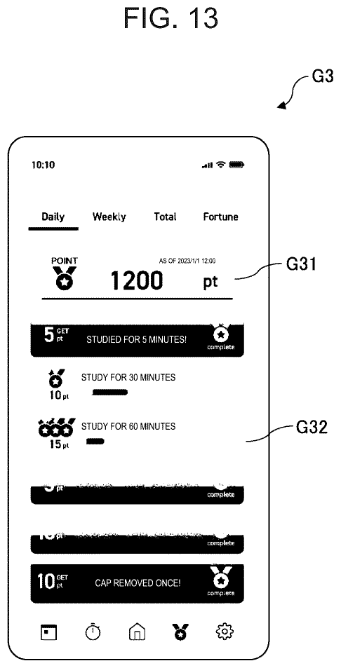

FIG. 13 is a diagram illustrating an example of a point management screen G3 displayed on the display unit 23 by the processing unit 27 executing the point management application program. The point management screen G3 includes a total point indication G31 for indicating a total of points acquired by a user and the like, and an achievement indication G32 for indicating a graph showing the degree of achievement for each item related to a writing operation and the corresponding points acquired. For example, in the achievement indication G32, the degree of achievement with respect to a default target or a target set by a user is displayed by a graphic such as a bar graph or a medal, or the number of points or the like. A point acquisition status may be switched and displayed for every day, every week, or the entire period by selecting a tab.

The points acquired by each user may be stored and managed in the communication terminal 2 or may be stored and managed in an external management server connected to the communication terminal 2 via a network. The points acquired by the point management application program can be exchanged for, for example, digital data, goods or services, or can be donated.

The application program corresponding to the writing instrument 3 may be a state display application program that displays the state of the writing instrument 3 on the display unit 23 of the communication terminal 2.

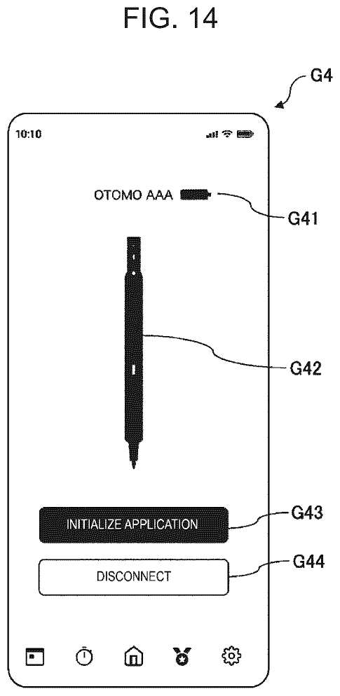

FIG. 14 is a diagram illustrating an example of a state display screen G4 displayed on the display unit 23 by the processing unit 27 executing the state display application program. The state display screen G4 includes a remaining battery level G41 of the writing instrument 3, an illustration G42 imitating the writing instrument 3, an application initialization button G43, and a connection setting button G44.

The illustration G42 indicates information on the inclination or the angle of the writing instrument 3. For example, the inclination or the angle of the writing instrument 3 is displayed by inclining the illustration G42 in conjunction with the writing instrument 3. The inclination and the angle can be obtained by detecting the direction of gravitational acceleration with an acceleration sensor included in the writing instrument 3. In addition to the inclination and the angle of the writing instrument 3, information indicating whether the communication terminal 2 and the writing instrument 3 communicate with each other may be displayed using an icon or the like, or information indicating whether the writing pressure is detected may be displayed.

The application initialization button G43 is an object for initializing information and conditions set in the state display application program. The connection setting button G44 is an object for connecting and disconnecting communication between the writing instrument 3 and the communication terminal 2. The information indicating the state of the writing instrument 3 displayed by the state display screen G4 is not limited to that described above.

While the state display application program is being executed, the control unit 272 acquires information on the state of the writing instrument 3 at a predetermined frequency via the communication unit 22. For example, the control unit 272 acquires the remaining battery level at a frequency of about once per minute to 500 times per second, and acquires the information detected by the sensor 42 such as the writing pressure, the inclination, and the angle at a frequency of about once per second to 500 times per second. The frequency may be automatically set in consideration of the remaining battery level and power consumption.

Note that the sensors for detecting a motion, such as the acceleration sensor, the pressure sensor, or the Hall sensor described above, may be included in a motion detection device. The same effect can be obtained by acquiring the information related to the body movements and the motions described above by the motion detection device.

The motion detection device may be an attachment type that can be attached to the writing instrument. In that case, the motion detection device can be regarded as the writing instrument.

Although a case in which the determination unit 492 is provided at the writing instrument 3 has been described above, the determination unit 492 may be provided at the communication terminal 2. In that case, the writing instrument 3 transmits a signal from the sensor to the communication terminal 2, the communication terminal 2 receives the signal transmitted from the writing instrument 3, and the determination unit of the communication terminal 2 determines whether the motion of the writing instrument 3 is the predetermined motion based on the received signal. When the determination unit of the communication terminal 2 determines that the motion of the writing instrument 3 is the predetermined motion, the control unit of the communication terminal 2 performs control of executing the first operation without an operation by a user.

As described above, according to the present embodiment, the writing instrument 3, the communication system 1, and the communication terminal 2 that enable a user to start communication with a simple operation are provided.

It should be understood by those skilled in the art that various changes, substitutions, and modifications can be made without departing from the scope of the present invention. For example, the above-described embodiment and modified may be appropriately combined and implemented within the scope of the present invention.

### REFERENCE SIGNS LIST

3 Writing instrument
4 Barrel
421 Magnetic field sensor
422 Inertial sensor
423 Pressure sensor
491 Acquisition unit
492 Determination unit
493 Transmission unit
494 Notification control unit
5 Cap
512 Recess
52 Magnet
53 Decorative member

1. An information processing system comprising:
a writing instrument having a communication function and
an electronic device configured to communicate with the writing instrument, wherein
the writing instrument includes:
a sensor configured to detect a motion;
a processor configured to
determine whether the motion detected by the sensor is a predetermined motion; and
transmit a predetermined signal to the electronic device, and
the processor transmits, to the electronic device, the predetermined signal for causing the electronic device to execute a first operation without an operation by a user, when determining that the motion detected by the sensor is the predetermined motion.

2. The information processing system according to claim 1, wherein the first operation is executed in preference to a second operation executed by the electronic device.

3. The information processing system according to claim 1, wherein the first operation is an operation of superimposing another indication on an indication displayed on a display, the indication being executed by the electronic device as a second operation.

4. The information processing system according to claim 1, wherein the first operation is an operation of inhibiting a display operation on a display, the display operation being executed by the electronic device as a second operation.

5. An information processing system comprising:
a writing instrument having a communication function; and
an electronic device configured to communicate with the writing instrument, wherein
the writing instrument includes:
a sensor configured to detect a motion; and
a first processor configured to transmit a signal from the sensor to the electronic device, and
the electronic device includes:
a second processor configure to
receive the signal transmitted from the first processor;
determine whether the motion of the writing instrument is a predetermined motion, based on the received signal; and
perform control of causing the electronic device to execute a first operation without an operation by a user, when determining that the motion of the writing instrument is the predetermined motion.

6. The information processing system according to claim 5, wherein the first operation is executed in preference to a second operation executed by the electronic device.

7. The information processing system according to claim 5, wherein the first operation is an operation of superimposing another indication on an indication displayed on a display, the indication being executed by the electronic device as a second operation.

8. The information processing system according to claim 5, wherein the first operation is an operation of inhibiting a display operation on a display, the display operation being executed by the electronic device as a second operation.

9. A writing instrument communicating with an electronic device, the writing instrument comprising:
a sensor configured to detect a motion; and
a processor configured to
determine whether the motion detected by the sensor is a predetermined motion; and
transmit a predetermined signal to the electronic device, wherein
the processor transmits, to the electronic device, the predetermined signal for causing the electronic device to execute a first operation without an operation by a user, when determining that the motion detected by the sensor is the predetermined motion.

10. The writing instrument according to claim 9, wherein the sensor includes at least one of an acceleration sensor that detects an acceleration applied to the writing instrument, an angular velocity sensor that detects an angular velocity applied to the writing instrument, a pressure sensor that detects a pressure applied to the writing instrument during writing, and a sensor that detects knocking or rotation for causing a lead of the writing instrument to come out.

11. The writing instrument according to claim 9, further comprising a cap configured to accommodate a magnet and to be detachable from a barrel, wherein
the sensor includes a magnetic field sensor that is accommodated in the barrel and detects a magnetic field generated by the magnet,
the processor determines whether the cap is removed from the barrel as the predetermined motion, based on the magnetic field detected by the magnetic field sensor, and
the processor transmits the predetermined signal when the cap is removed from the barrel.

12. The writing instrument according to claim 9, wherein the predetermined signal is a Bluetooth Low Energy (BLE) beacon signal.

13. An electronic device communicating with a writing instrument, the electronic device comprising:
a processor configured to
receive a signal transmitted from the writing instrument; and
execute a predetermined operation, wherein
the processor executes a first operation without an operation by a user, when receiving a predetermined signal transmitted from the writing instrument, the predetermined signal being transmitted when a predetermined motion is performed.
